(19) United States
(12) Patent Application Publication
(10) Pub. No.: US 2008/0144082 A1
(43) Pub. Date: Jun. 19, 2008

(54) Method and System for Communicating in a Network

(75) Inventor: Thomas F. Kister, Chalfont, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/610,308

(22) Filed: Dec. 13, 2006

(51) Int. Cl. G06F 3/12

(52) U.S. Cl. 358/1.15

(57) ABSTRACT

A method and system (102) for communicating in a network (100) is provided. The method comprises receiving (204) at least one identifier associated with a communication target. The at least one identifier is received at a first communication device (102). Further, the method comprises acquiring (206) one or more images from at least one of the plurality of image collecting devices connected to the network. Moreover, the method comprises comparing (208) the at least one identifier with the one or more images acquired from at least one of the plurality of image collecting devices and establishing (210) communication between the first communication device and at least one other communication device connected to the network.

### FIELD OF THE INVENTION

The present invention relates in general to communication networks, and more specifically, to a method and system for communicating in a network.

### BACKGROUND OF THE INVENTION

A communication network allows two or more users to communicate with each other with the help of communication devices. Examples of the communication devices include, but are not limited to, telephones, mobile phones, intercoms, computers, laptops and Personal Digital Assistants (PDAs). Further, for communication between two or more communication devices, communication links needs to be established between the two or more communication devices. Typically, the process of establishing the communication links is initiated when a user transmits a communication request by dialing the numbers associated with the pertinent communication devices. Other users receiving the communication request at the pertinent communication devices can respond by accepting or denying the communication request.

To facilitate communications over relatively smaller areas, intercom networks are employed. Conventional intercom networks include a plurality of interconnected communication devices. Typically, in an intercom network, a point to point connection can be established between two communication devices for communication. Today, many homes and offices employ intercom networks for in-house communications. For example in a home furnished with intercom networks, a mother in a kitchen can talk to a child in a bedroom by pressing a button and establishing a connection between the communication devices in the kitchen and the bedroom. However, if the child is not in the bedroom, the mother would not be able to communicate with the child. The mother will then need to find the current location of the child and connect to the communication device at that location. Moreover, if a person on the other side does not respond, a caller might have to shout over the communication device.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments, and to explain various principles and advantages, all in accordance with the present invention.

FIG. 1 illustrates a network in which various embodiments of the present invention can be practiced;

FIG. 2 illustrates a flow diagram depicting a method for directing communications within a network, in accordance with various embodiments of the present invention; and

FIG. 3 illustrates a block diagram of a communication device, in accordance with various embodiments of the present invention.

Skilled artisans will appreciate that the elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION

Before describing in detail the particular method and system for communicating in a network, in accordance with various embodiments of the present invention, it should be observed that the present invention resides primarily in combinations of method steps and apparatus components related to the method and system for communicating in a network. Accordingly, the method steps have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

In this document, the terms “comprises,” “comprising,” or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by “comprises . . . a” does not, without more constraints, preclude the existence of additional identical elements in the process, method, article or apparatus that comprises the element. The term “another,” as used in this document, is defined as at least a second or more. The terms “includes” and/or “having”, as used herein, are defined as comprising.

One embodiment of the present invention provides a method for directing communications in a network. The network includes a plurality of image collecting devices. The method includes receiving at least one identifier associated with a communication target at a first communication device connected to the network. Further, the method includes acquiring one or more images from at least one of the plurality of image collecting devices connected to the network. Furthermore, the method includes comparing the at least one identifier, received at the first communication device, with the one or more acquired images. Moreover, the method includes establishing, based on the comparison, communication between the first communication device and at least one other communication device connected to the network and co-located with one of the plurality of image collecting devices.

Another embodiment of the present invention provides a communication device adapted to operate within a network. The network includes a plurality of communication devices and a plurality of image collecting devices. The communication device includes an interface for receiving at least one identifier associated with a communication target. Further, the communication device includes a receiver for acquiring one or more images from at least one of the plurality of image collecting devices connected to the network. Furthermore, the communication device includes a processor for comparing the acquired one or more images with the at least one identifier. Moreover, the communication device includes a means for establishing communication between the communication device and at least one other communication device connected to the network, based on the comparison.

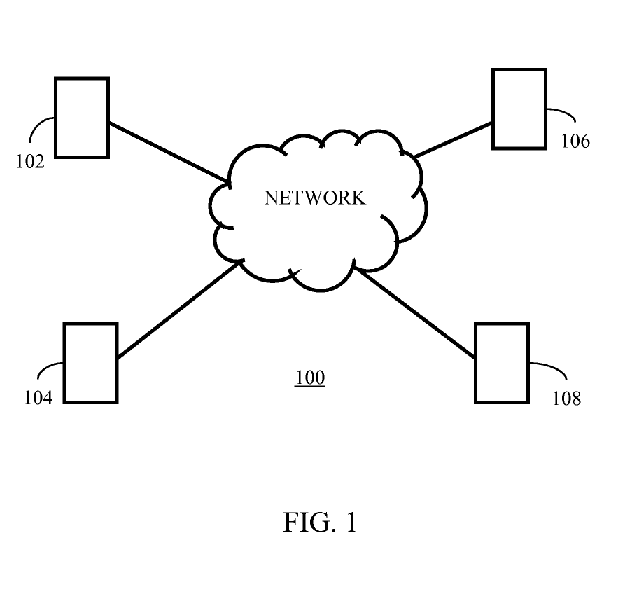

FIG. 1 illustrates a network 100 in which various embodiments of the present invention can be practiced. The network 100 can be, for example, an intercom network. The network 100 includes a plurality of communication devices, for example, communication devices 102, 104, 106, and 108. Examples of the communication devices 102, 104, 106, and 108 can be telephones, Push-to-talk (PTT) phones, laptops, Personal Digital Assistants (PDA's) and intercoms. The communication devices 102, 104, 106, and 108 can be interconnected for communication in places such as offices, homes or in large public buildings. The communication devices 102, 104, 106, and 108 can be connected in the network 100 by using wired or wireless connections. It will be apparent to those skilled in the art, that the communication devices 102, 104, 106, and 108 can be connected in the network 100 in various topologies. These topologies include ring topology, bus topology, star topology, and mesh topology among others. The communication devices 102, 104, 106, and 108 can be placed at different locations, for example, an office or home. Typically, to establish connections for communication, a first user at a communication device, for example, the communication device 102 can call a second user at another communication device, for example, the communication device 104 by dialing number(s) associated with the communication device 104. The first user and the second user can communicate once a connection is established between the communication device 102 and the communication device 104. The first user at the communication device 102 can also intend to communicate with more than one communication devices connected to the network 100. For one embodiment, the communication devices 102, 104, 106, and 108 can be at different locations in a house. For example, the communication device 102 can be at the kitchen and the communication device 104 can be in the bedroom. The first user at the kitchen can use the communication device 102 to talk to the second user in the bedroom by connecting to the communication device 104.

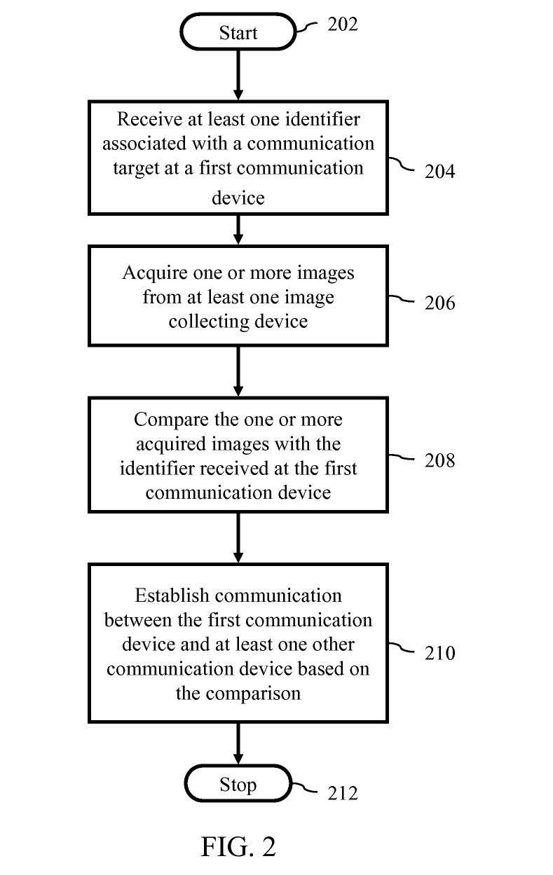

FIG. 2 illustrates a flow diagram depicting a method for directing communications within the network 100, in accordance with various embodiments of the present invention. During the process of establishing communication, the first user at the communication device 102 who wishes to contact or find a communication target, identifies a communication target. On identification of the communication target, the communication device 102 establishes a communication link with another communication device located in the vicinity of the communication target. The method of directing communications in the network 100 is initiated at step 202. At step 204, a communication device connected to the network 100, for example, the communication device 102, receives at least one identifier associated with a communication target. The at least one identifier can identify the communication target and is selected from a menu of identifiers presented to the first user at the communication device 102. For one embodiment, the at least one identifier can be, for example, a number, an image and/or a biometric parameter. For example, an identifier for a person can be the person's facial image. The identifier can identify the communication target that the first user at the communication device 102 intends to communicate with. In this embodiment, the communication target can be, for example, a specific person and/or a specific class of person. For another embodiment, the identifier can identify a communication target that the first user at the communication device 102 intends to search. In this embodiment, the communication target can be, for example, a person, an animal and/or a vehicle.

On receiving the identifier from the user, the communication device 102 sends the at least one identifier to each communication device connected to the network 100. Further, at least one image collecting device of the plurality of image collecting devices co-located with the communication devices capture images of an area around them. The plurality of image collecting devices can be, for example, a video camera, a thermal image sensor and/or a still image camera. The plurality of image collecting devices capture one or more images based on a predefined condition. For one embodiment of the present invention, the predefined condition can be receiving the at least one identifier from the communication device 102. For another embodiment of the present invention, the predefined condition can be receiving the at least one identifier from a central server. The central server can send the at least one identifier, when the user at one of the communication devices in the network 100 enters a key identifying the communication target. For yet another embodiment of the present invention, the predefined condition can be based on a predefined time interval. For example, the predefined time interval can specify the intervals at which the images can be acquired. Once the predefined condition is satisfied, the at least one image collecting device can start capturing images of its surrounding. At step 206, the communication device 102 acquires one or more images from at least one of the plurality of image collecting devices connected to the network 100. Alternatively, at step 206, the one or more images from the at least one of the plurality of image collecting devices are acquired by a central server. At step 208, the one or more images acquired from the at least one of the plurality of image collecting devices are compared with the at least one identifier received by the communication device 102. When the one or more images are acquired by the central server, the comparison between the at least one identifier and the one or more images take places on the central server. If at step 208, one of the one or more images acquired from the plurality of image collecting devices matches with the at least one identifier, then the flow diagram is redirected to step 210. At step 210, a communication link is established between the communication device 102 and at least one other communication device connected to the network 100. The at least one other communication device is the one which is co-located with at least one image collecting device that captures the one or more images that match with the at least one identifier. The method is terminated at step 212.

For one embodiment of the present invention, the user at the communication device 102 can select the at least one identifier from the menu of identifiers. The at least one identifier is then sent to each of the communication devices connected to the network 100. Each of the plurality of image collecting devices co-located with the communication devices connected to the network 100, capture one or more images of the area around them at predefined time intervals after receiving the at least one identifier from the communication device 102. Each of the other communication devices then compare the at least one identifier with the one or more images acquired from at least one co-located image collecting device. If the one or more images acquired by at least one of the other communication devices matches the at least one identifier, then a communication link is established between the at least one communication device and the communication device 102.

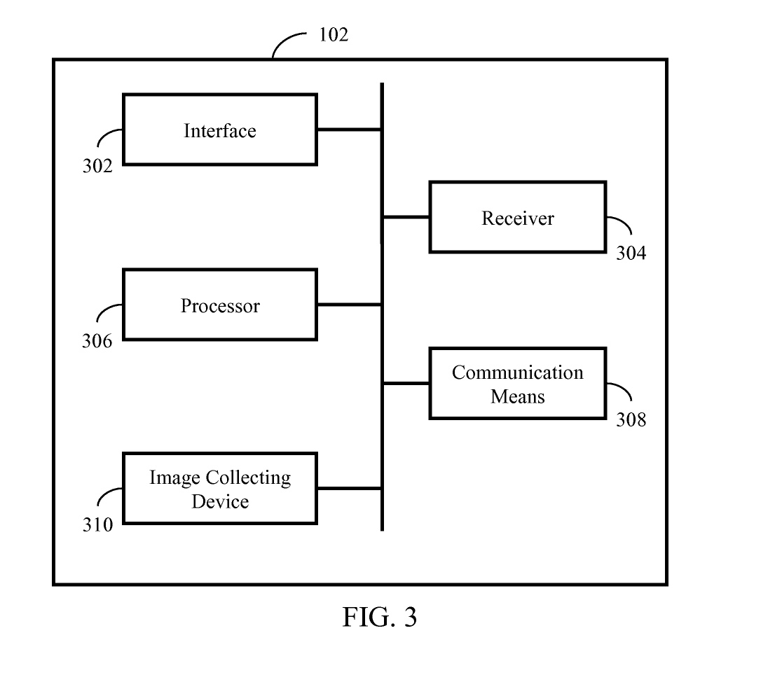

FIG. 3 illustrates a block diagram of the communication device 102, in accordance with various embodiments of the present invention. For one embodiment of the present invention, the communication device 102 includes an interface 302, a receiver 304, a processor 306, a communication means 308 and an image collecting device 310. During the process of initiating a call with a communication target, a user at one of the communication devices 102, 104, 106, and 108 can select at least one identifier from a menu of identifiers. The at least one identifier can be, for example, a number, an image and/or a biometric parameter. The at least one identifier can identify an associated communication target. For example, an identifier for a person can be his/her facial image. Further, for one embodiment, the at least one identifier can identify the communication target that the first user at the communication device 102 intends to communicate with. In this embodiment, the communication target can be, for example, a specific person and/or a specific class of person. For another embodiment, the identifier can identify a communication target that the first user at the communication device 102 intends to search. In this embodiment, the communication target can be, for example, a person, an animal and/or a vehicle. Further, the interface 302 at the communication device 102 receives the identifier selected by the first user at the communication device 102. On receiving the identifier, the image collecting device 310 collects a plurality of images from its surroundings and sends it to the receiver 304. The receiver 304 is capable of acquiring the plurality of images from the image collecting device 310. Further, the processor 306 compares the acquired plurality of images with the identifier received by the interface 302. Based on the comparison of the plurality of images and the identifier, the communication means 308 establishes a communication link between the communication device 102 and at least one other communication device connected to the network 100. For one embodiment, the communication device 102 can include a memory. The memory can be used for storing, for example, a menu of identifiers.

As depicted in the FIG. 3, for an embodiment of the present invention the image collecting device 310 is integrated with the communication device 102. For another embodiment of the present invention, the image collecting device 310 can be fitted separately to the communication device 102. Further, there can be a plurality of image collecting devices in an area covered by the communication device 102. Once the communication device 102 receives the at least one identifier through the interface 302, the plurality of image collecting devices in the area covered by the communication device 102 capture images of the area covered by the communication device 102.

Various embodiments of the present invention provide an efficient way of communicating in the network 100. The at least one identifier is used to confirm the presence of a communication target in the vicinity of a communication device. During the process of communicating with a particular person, or a class of persons, the initiator does not need prior knowledge regarding the location of that particular person or class or persons. Instead the initiator selects an identifier that identifies the person or class of persons he/she wishes to communicate with and can proceed to place the call. In case of intercom systems, where a person calls another person and starts talking directly, the present invention can prevent screaming by a person who is trying to call, in case the other person is not present at the location.

It will be appreciated that the method and system for communicating in a network described herein may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power source circuits, and user input devices. As such, these functions may be interpreted as steps of method and system for communicating in a network. Alternatively, some or all the functions could be implemented by a state machine that has no stored program instructions, or in one or more application-specific integrated circuits (ASICs), in which each function, or some combinations of certain of the functions, are implemented as custom logic. Of course, a combination of the two approaches could also be used. Thus, methods and means for these functions have been described herein.

It is expected that one with ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one with ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. A method for directing communications within a network including a plurality of image collecting devices, the method comprising:
receiving at a first communication device connected to the network at least one identifier associated with a communication target;
acquiring one or more images from at least one of the plurality of image collecting devices connected to the network;
comparing the one or more acquired images with the identifier received at the first communication device;
establishing, based upon the comparison, communications between the first communication device and at least one other communication device connected to the network and co-located with one of the plurality of image collecting devices.

2. The method as recited in claim 1, wherein the communication target is a specific person.

3. The method as recited in claim 1, wherein the communication target is a specific class of person.

4. The method as recited in claim 1, further comprising selecting the at least one identifier, received at the first communication device, from a menu of identifiers.

5. The method as recited in claim 1, wherein at the at least one identifier received at the first communication device is an image.

6. The method as recited in claim 1, wherein at least one of the plurality of image collecting devices comprises at least one of a video camera, a thermal imaging sensor and a still image camera.

7. The method as recited in claim 1, wherein acquiring the one or more images from at least one of the plurality of image collecting devices connected to the network is based upon a predefined condition.

8. The method as recited in claim 1, further comprising acquiring the one or more images from at least one of the plurality of image collecting devices connected to the network at a predefined interval.

9. A communication device adapted to operate within a network including a plurality of communication devices and image collecting devices, the communication device comprising:
an interface for receiving at least one identifier associated with a communication target;
a receiver for acquiring one or more images from at least one of the plurality of image collecting devices connected to the network;
a processor for comparing the acquired one or more images to the received at least one identifier; and
a means for establishing, based upon the comparison, communications between the communication device and at least one other communication device connected to the network.

10. The communication device of claim 9, wherein the communication target is a specific person.

11. The communication device of claim 9, wherein the communication target is a specific class of person.

12. The communication device of claim 9, wherein the at least one identifier received is an image.

13. The communication device of claim 12, wherein the image is collected from at least one of a video camera, a thermal imaging sensor and a still image camera.

14. The communication device of claim 10, wherein at least one identifier received is a biometric parameter.

15. The communication device of claim 14 further comprising a memory for storing one or more identifiers.
